(19) United States
(12) Patent Application Publication
(10) Pub. No.: US 2002/0059452 A1
(43) Pub. Date: May 16, 2002

(54) Method and system for transferring data in mobile IP

(75) Inventors: Hidetoshi Yokota, Saitama (JP); Koichi Hirose, Tokyo (JP); Osamu Maeshima, Tokyo (JP); Akira Idoue, Saitama (JP); Toshihiko Kato, Saitama (JP)

Correspondence Address: ARMSTRONG,WESTERMAN & HATTORI, LLP, 1725 K STREET, NW., SUITE 1000, WASHINGTON, DC, 20006, US

(73) Assignee: KDDI Corporation, Tokyo (JP)

(21) Appl. No.: 09/950,638

(22) Filed: Sep. 13, 2001

(30) Foreign Application Priority Data
Sep. 14, 2000 (JP) 2000-280507

(51) Int. Cl. G06F 15/173

(52) U.S. Cl. 709/238

(57) ABSTRACT

A method of transferring data in mobile IP of the present invention comprises the steps of: causing the home agent(HA) to store as a care-of-address of the mobile host (MH) an address of the foreign agent (FA) received from MH; causing a DNS server in the home network (HN) to demand the care-of-address of MH from HA in response to the request of the communication terminal about the IP address and the care-of-address of MH; causing HA to provide the DNS server with the care-of-address of MH upon receiving the demand; and causing the DNS server to deliver the IP address and the care-of-address of MH to the communication terminal.

### BACKGROUND OF THE INVENTION

1. Field of the Invention

The present invention relates to a method and an apparatus for transferring data in the mobile IP over the most optimum route from a communication terminal to a mobile host which has been moved from a home network to a foreign network.

2. Description of the Related Art

In the Internet, the network address of an IP address assigned to a mobile host (MH) is unique to the home network (HN) to which MH is subscribed. When MH is moved into a foreign network (FN), it is needed to obtain an IP address containing the network address unique to FN.

The mobile IP defined by RFC (request for comments) 2002 is provided as a method of continuing the connection without changing the IP address, where even if MH has been moved into another network, it virtually remains linked to HN.

For implementing the mobile IP, HN includes a node called a home agent (HA) as shown in FIG. 3. Also, FN is arranged to include a node called a foreign agent (FA).

As MH has an available IP address provided (for use) in HN, it can receive IP packets while being linked to HN. When MH has been moved into FN, it recognizes that it has been removed from HN to FN by the information broadcast periodically from FA and notifies HA in HN of the IP address of FA in FN.

This is followed by HA receiving all the IP packets addressed to MH from a communication terminal A (denoted by (1) in FIG. 3). HA encapsulates the IP packet addressed to MH with an IP packet which carries the IP address of FA (for IP tunneling) as the destination and transfers it to FA over the Internet (as denoted by (2) in FIG. 3). In turn, FA decapsulates the received data to obtain the IP packet addressed to MH and transfers them to MH (as denoted by (3) in FIG. 3).

In the communication over the mobile IP, the IP packets addressed to MH linked to FN are transmitted via HA and their route may hardly be shortest. An improved method known as route optimization is provided for simplifying exchange of the packets.

The route optimization allows HA to store the IP address of MH and the IP address of FA or care-of-address (COA) in a binding update message (BUM) and notify the communication terminal A (denoted by (4) in FIG. 3).

Based on this information, the communication terminal A encapsulates data to be sent to MH within an IP packet and transfers it directly to FA not via HA (as denoted by (5) in FIG. 3). Then, FA decapsulates the received data and transfers its data to MH.

The prior data transfer procedure will now be explained in more detail referring to a sequence for communication shown in FIG. 4.

Step 1: The communication terminal A requests of the DNS server in HN the IP address of MT1.HOME1.com which is the (fully qualified) domain name (FQDN) of MH.

Step 2: The DNS server replies and sends the IP address of MH, GA1, to the communication terminal A.

Step 3: The communication terminal A gets access to MH by GA1 as its IP address.

Step 4: The transferred data addressed by GA1 is encapsulated by HA with the IP address (FA0) of FA and transferred to FA.

Step 5: FA extracts the data from the encapsulated packet and delivers it to MH.

When the communication terminal A supports route optimization, the following procedure of optimization is carried out.

Step 6: HA stores the IP address of FA, FA0, as COA of MH in BUM and sends it to the terminal A.

Step 7: The communication terminal A encapsulates the data and transfers it to FA.

Step 8: FA extracts the data from the encapsulated packet and delivers it to MH.

From this point, the steps 7 and 8 are repeated. As a result, HN is less loaded for the data transfer. The data can thus be transferred from the terminal A to MH via the shortest route.

In the conventional route optimization, the data transfer will be conducted over the shortest route once the terminal A has received BUM. However, before the terminal A receives BUM, each data addressed to MH is transferred via HA. It is hence desired to further minimize or optimize the route.

### SUMMARY OF THE INVENTION

It is an object of the present invention to provide a method and a system for transferring data in the mobile IP which allows HN to be less loaded for the mobile IP data transfer and a communication terminal to transfer the data directly to MH from the biginning.

The present invention is characterized by following features in a method of transferring data in a mobile IP from a communication terminal to a MH which has been moved from its home network having a home agent function to a foreign network having a foreign agent function.

(1) The step of causing the home agent function to store as a care-of-address of the mobile host an address of the foreign agent function received from the mobile host; the step of causing a DNS server in the home network to demand the care-of-address of the mobile host to the home agent function in response to the request of the communication terminal about the IP address and the care-of-address of the mobile host; the step of causing the home agent function to provide the DNS server with the care-of-address of the mobile host upon receiving the demand; and the step of causing the DNS server to deliver the IP address and the care-of-address of the mobile host to the communication terminal.

(2) The step of causing the communication terminal to request of a DNS server an IP address and a care-of-address of the mobile host; the step of causing the communication terminal to receive the IP address and the care-of-address of the mobile host from the DNS server; and the step of causing the communication terminal to encapsulate the data to be transferred and the IP address of the mobile host with the IP packet which is addressed to the care-of-address of the mobile host.

According to the feature (1) of the present invention, HN for mobile hosts needs not to relay and transfer data received from one communication terminal to a mobile host in FN, hence allowing HA to handle less load of the data processing in mobile IP.

According to the feature (2) of the present invention, the transfer of data from a communication terminal to a mobile host can be carried out via a shorter route, thus ensuring no degradation in its quality.

### BRIEF DESCRIPTION OF THE DRAWINGS

FIG. 1 is a block diagram showing an arrangement of a communications network for embodying the present invention.

FIG. 2 is a diagram of a communication sequence according to the present invention.

FIG. 3 is a block diagram showing an arrangement of a conventional communications network.

FIG. 4 is a diagram of a conventional communication sequence.

### DETAILED DESCRIPTION OF THE PREFERRED EMBODIMENT

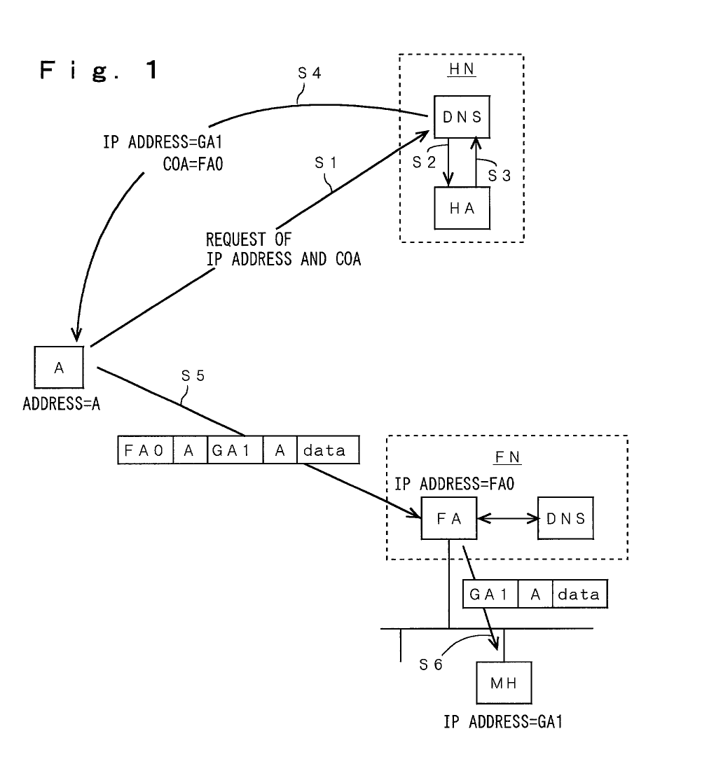

FIG. 1 is a block diagram showing an arrangement of a communications network for embodying the present invention.

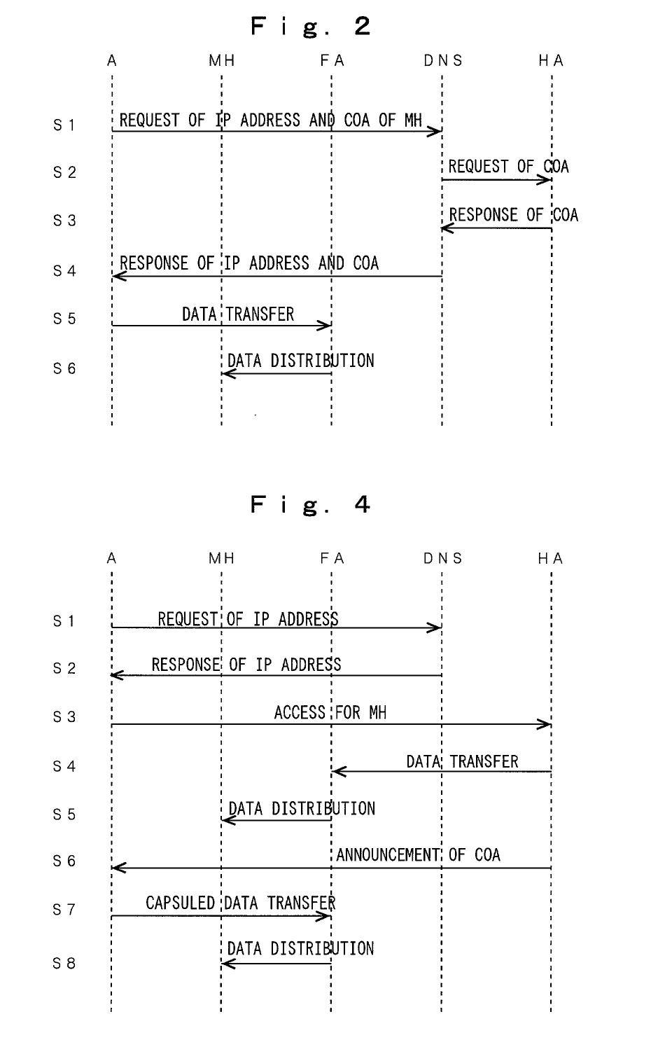

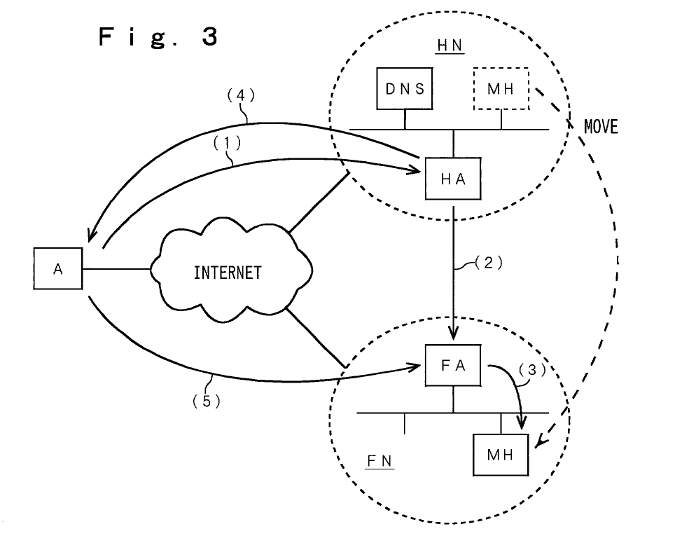

FIG. 2 is a diagram of a communication sequence according to the present invention.

MH which has been moved from HN to FN demands to register the mobile IP of FA when MH found FA. In response, FA accepts and transfers the registration response of the mobile IP to HA.

HA provides FA the registration response of the mobile IP corresponding to the registration request of the mobile IP from FA. The packet for the registration response of the mobile IP is then received by FA and transferred to MH. This allows HA to acknowledge COA of MH.

When the communication terminal A supporting the route optimization wants to transfer the data to MH in FN, the following steps 1 to 6 are carried out.

Step 1: The communication terminal A requests of a DNS server in HN the IP address of MT1.HOME1.com which is a domain name (FQDN) of MH and the IP address of FA or COA of MH.

Step 2: In response, the DNS server requests of HA COA of MH.

Step 3: HA provides the DNS server with FA0 which is the IP address of FA as COA of MH.

Step 4: The DNS server provides GA1 as the IP address of MH and FA0 as COA of MH.

Step 5: The communication terminal A encapsulates the data to be transferred and GA1 (the IP address of MH) with an IP packet of which the address is FA0 and sends it out.

Step 6: FA extracts the IP packet from its encapsulated form and delivers it to MH.

According to this embodiment, HN needs not to transfer the data received from the communication terminal A to FN, hence allowing HA to handle less load of the data processing in mobile IP. Also, the transfer of data from the communication terminal A to MH is carried out directly from the beginning and its route will be always shortest.

For registration of COA of MH, HA provides the DNS server with a TTL (time to live) indicative of a predetermined life time(expiration time). The DNS server stores the IP address of COA in a cache up to TTL. If the communication terminal A employs no route optimization, the encapsulation of data is disabled. Accordingly, COA is not stored in ARR (address resource record) but in other RRs such as TXT RR and used by only a communication terminal supporting the route optimization. This allows any communication terminal not supporting the route optimization to transfer data to GA1 as the destination address in the conventional manner.

The advantages of the present invention are as follows:

(1) The home network needs not to transfer data received from a communication terminal to a foreign network, hence allowing HA to handle less load of the data transfer in mobile IP.

(2) The data transfer from communication terminal to MH is carried out directly from the beginning and its route can be always shortest.

What is claimed is:

1. A method of transferring data in mobile IP from a communication terminal to a mobile host which has been moved from its home network having a home agent function to a foreign network having a foreign agent function, comprising the steps of:
causing the home agent function to store as a care-of-address of the mobile host an address of the foreign agent function received from the mobile host;
causing a DNS server in the home network to demand the care-of-address of the mobile host from the home agent function in response to the request of the communication terminal about the IP address and the care-of-address of the mobile host;
causing the home agent function to provide the DNS server with the care-of-address of the mobile host upon receiving the demand; and
causing the DNS server to deliver the IP address and the care-of-address of the mobile host to the communication terminal.

2. A method of transferring data in mobile IP from a communication terminal to a mobile host which has been moved from its home network having a home agent function to a foreign network having a foreign agent function, comprising the steps of:
causing the communication terminal to request of a DNS server an IP address and a care-of-address of the mobile host;
causing the communication terminal to receive the IP address and the care-of-address of the mobile host from the DNS server; and
causing the communication terminal to encapsulate the data to be transferred and the IP address of the mobile host with the IP packet which is addressed to the care-of-address of the mobile host.

3. A method of transferring data in mobile IP according to claim 1, wherein the communication terminal supports a technique of route optimization.

4. A method of transferring data in mobile IP according to claim 2, wherein the communication terminal supports a technique of route optimization.

5. A system for transferring data in mobile IP from a communication terminal to a mobile host, which has been moved from its home network to a foreign network, via not a home agent function of the home network, wherein the home network comprises:
the home agent function for storing as the care-of-address of the mobile host the address of the foreign agent function received from the mobile host; and
a DNS server for providing the communication terminal with the IP address of the mobile host in response to the request of the communication terminal about the IP address of the mobile host, wherein
the DNS server arranged for demanding the care-of-address of the mobile host from the home agent function in response to the request of the communication terminal about the care-of-address of the mobile host and delivering the care-of-address of the mobile host received from the home agent function to the communication terminal.

6. A system for transferring data in mobile IP from a communication terminal to a mobile host, which has been moved from its home network to a foreign network, via not a home agent function of the home network, wherein the communication terminal comprises:
a means for inquiring of the DNS server in the home network the IP address and the care-of-address of the mobile host;
a means for receiving the IP address and the care-of-address of the mobile host from the DNS server; and
a means for encapsulating the data to be transferred and the IP address of the mobile host with the IP packet which is addressed to the care-of-address of the mobile host for data transfer.
